(19) United States
(12) Patent Application Publication
(10) Pub. No.: US 2025/0303407 A1
(43) Pub. Date: Oct. 2, 2025

(54) Lateral Flow Devices and Methods

(71) Applicant: IDEXX Laboratories, Inc., Westbrook, ME (US)

(72) Inventor: Justin Griffin, Scarborough, ME (US)

(73) Assignee: IDEXX Laboratories, Inc., Westbrook, ME (US)

(21) Appl. No.: 19/078,467

(22) Filed: Mar. 13, 2025

Related U.S. Application Data
(60) Provisional application No. 63/571,823, filed on Mar. 29, 2024.

(51) Int. Cl. B01L 3/00

(52) U.S. Cl. CPC B01L 3/5023; B01L 3/502715; B01L 2200/027; B01L 2200/16; B01L 2300/069; B01L 2400/0406

(57) ABSTRACT

A device for testing a fluid sample. The device includes a sample well configured to receive the fluid sample. The device also includes a reagent well, adjacent to the sample well, the reagent well comprising a fluid reagent and a wick. The device also includes a housing configured to actuate the wick, wherein, once actuated, the wick is configured to provide a first fluidic communication between the sample well and the reagent well and support a first directional flow of the fluid reagent from the sample well to the reagent well. The device also includes a test strip configured to provide a second fluidic communication between the sample well and an absorbent pad and support a second directional flow of the fluid sample and the fluid reagent from the sample well to the absorbent pad.

### CROSS-REFERENCE TO RELATED APPLICATIONS

This application claims the benefit of co-pending U.S. Provisional Patent Application Ser. No. 63/571,823, filed Mar. 29, 2023, which is hereby incorporated by reference in its entirety.

### FIELD OF THE DISCLOSURE

The disclosure relates to directional flow devices and methods for testing samples, for example, to determine the presence of analytes in biological, industrial and environmental samples.

### BACKGROUND

Directional flow test devices have been used for the determination of numerous analytes in samples. What remains needed in the art, however, are devices that limit the amounts and types of materials and limit the amount user interaction while providing timely and accurate results.

### SUMMARY

In an example, a device for testing a fluid sample is disclosed. The device includes a sample well configured to receive the fluid sample. The device also includes a reagent well, adjacent to the sample well, the reagent well comprising a fluid reagent and a wick. The device additionally includes a housing configured to actuate the wick, wherein, once actuated, the wick is configured to provide a first fluidic communication between the sample well and the reagent well and support a first directional flow of the fluid reagent from the sample well to the reagent well. The device further includes a test strip configured to provide a second fluidic communication between the sample well and an absorbent pad and support a second directional flow of the fluid sample and the fluid reagent from the sample well to the absorbent pad.

In another implementation, a method for testing a fluid sample includes receiving the fluid sample in a sample well. The method additionally includes actuating, via a housing, a wick between the sample well and a reagent well, wherein the reagent well comprises a fluid reagent, and wherein the wick, once actuated, is configured to provide a first fluidic communication between the sample well and the reagent well and support a first directional flow of the fluid reagent from the sample well to the reagent well. The method also includes performing a test on the fluid sample on a test strip, wherein the test strip is configured to provide a second fluidic communication between the sample well and an absorbent pad and support a second directional flow of the fluid sample and the fluid reagent from the sample well to the absorbent pad, and wherein performing the test on the fluid sample is based on the second directional flow of the fluid sample and the fluid reagent from the sample well to the absorbent pad.

In another implementation, a system for testing a fluid sample includes a testing device. The testing device includes a sample well configured to receive the fluid sample. The testing device also includes a reagent well, adjacent to the sample well, the reagent well comprising a fluid reagent and a wick. The testing device additionally includes a housing configured to actuate the wick, wherein, once actuated, the wick is configured to provide a first fluidic communication between the sample well and the reagent well and support a first directional flow of the fluid reagent from the sample well to the reagent well. The testing device further includes a test strip configured to provide a second fluidic communication between the sample well and an absorbent pad and support a second directional flow of the fluid sample and the fluid reagent from the sample well to the absorbent pad. The system also includes an imaging device. The imaging device includes an imaging sensor configured to capture one or more images of the test strip. The imagining device additionally includes a computing device configured to analyze the captured one or more images.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The above, as well as additional features will be better understood through the following illustrative and non-limiting detailed description of example embodiments, with reference to the appended drawings.

FIG. 1 illustrates a simplified block diagram of an example computing device, according to an example embodiment.

FIG. 2A illustrates a device for testing a fluid sample, according to an example embodiment.

FIG. 2B illustrates a device for testing a fluid sample, according to an example embodiment.

FIG. 2C illustrates a device for testing a fluid sample, according to an example embodiment.

FIG. 3A illustrates a device for testing a fluid sample, according to an example embodiment.

FIG. 3B illustrates a device for testing a fluid sample, according to an example embodiment.

FIG. 4 illustrates a test strip, according to an example embodiment.

FIG. 5 illustrates a computing system configured for use with an imaging device and a mobile computing device, according to an example embodiment.

FIG. 6 illustrates a method, according to an example embodiment.

All the figures are schematic, not necessarily to scale, and generally only show parts which are necessary to elucidate example embodiments, wherein other parts may be omitted or merely suggested.

### DETAILED DESCRIPTION

Example embodiments will now be described more fully hereinafter with reference to the accompanying drawings. That which is encompassed by the claims may, however, be embodied in many different forms and should not be construed as limited to the embodiments set forth herein; rather, these embodiments are provided by way of example. Furthermore, like numbers refer to the same or similar elements or components throughout.

In various aspects, the disclosure provides directional flow devices and methods for testing liquid samples. The term “analyte,” as used herein, generally refers to the substance, or set of substances, in a sample that are detected and/or measured. In some embodiments, the analyte is an “antigen,” which as used herein generally refers to a substance that is capable, under appropriate conditions, of reacting with an antibody specific for the antigen. In some embodiments, the analyte is an antibody.

The term “sample,” as used herein, generally refers to a sample of tissue, excreted product, or fluid from a human or animal including, but not limited to whole blood, plasma, serum, spinal fluid, lymph fluid, abdominal fluid (ascites), the external sections of skin, respiratory, intestinal and genitourinary tracts, tears, saliva, urine, blood cells, tumors, organs, tissue, feces, fine needle aspirates and in vitro cell culture constituents. Samples may also include industrial or environmental samples that require analysis. Samples may require mechanical or chemical processing prior to analysis (e.g, separation, filtering, centrifugation, chemical modification of sample constituents). As used herein, samples include both raw samples and/or processed samples.

The term “immunoassay,” as used herein, generally refers to a test that employs antibody and antigen complexes to generate a measurable response. In various aspects, one or more reagents associated with the device include a labeled analyte/antigen or labeled antibody that may be used to provide a detectable signal associated with the presence or absence of analyte in a sample using well known immunoassay techniques, Including, for example sandwich immunoassays, competitive immunoassays, homogeneous immunoassays, and heterogeneous immunoassays. Immunoassays that require separation of bound antibody: antigen complexes are generally referred to as “heterogeneous immunoassays,” and immunoassays that do not require separation of antibody: antigen complexes are generally referred to as “homogeneous immunoassays.”

Antigen and antibody complexes are formed by the binding of antigen and antibody molecules. When one of either the antibody or antigen is labeled, the label is associated with the immune complex as a result of the binding between the antigen and antibody.

The term “antibody,” as used herein, generally refers to a glycoprotein produced by B lymphocyte cells in response to exposure to an antigen and binds specifically to that antigen. The term “antibody” is used in its broadest sense and specifically covers monoclonal antibodies, polyclonal antibodies, multispecific antibodies (e.g., bispecific antibodies), and antibody fragments so long as they exhibit the desired biological activity. Antibody fragments refers to a portion of a full-length antibody, generally the antigen binding or variable domain thereof. Specifically, for example, antibody fragments may include Fab, Fab′, F(ab′)2, and Fv fragments; diabodies; linear antibodies; single-chain antibody molecules; and multispecific antibodies from antibody fragments.

While immunoassays are the dominating form of binding reactions in the industry, the disclosure includes other binding assays that use binding partners for analytes, e.g., nucleic acid hybridization assays, ligand/receptor binding assays, protein/protein interactions, and aptamer/protein interactions.

In other aspects, the analyte may react with reagents present on a test strip to form a detectable signal (e.g., an enzyme/substrate or other chemical reaction that produces a detectable signal in the presence of the analyte).

According to the embodiments described herein, a sample suspected of containing an analyte is added to an area of the device for receiving the sample. The device allows for directional flow (e.g., lateral flow) of the sample across one or more test strips of the device so that the sample encounters the necessary reagents for an analysis method that allows for the determination of the presence and/or amount of the analyte(s) in the sample.

Typically, lateral flow devices perform a single test and/or provide a single testing result. Embodiments of the present disclosure provide a directional flow device for testing a fluid sample which is configured to perform multiple tests (e.g., detecting the presence of one more analytes) on a sample simultaneously. The directional flow device utilizes a system of wells and one or more wicks to support delivery of reagents and directional flow of sample and reagents across one or more test strips. The device includes a housing configured to actuate the one or more wicks in a single step with minimal user interaction.

Test strips are generally in the form of a membrane or matrix made of materials that support lateral flow of liquids. The suitable materials include fibrous mats composed of synthetic or natural fibers (e.g., glass or cellulose-based materials or thermoplastic polymers, such as, polyethylene, polypropylene, or polyester); sintered structures composed of particulate materials (e.g., glass or various thermoplastic polymers); or cast membrane films composed of nitrocellulose, nylon, polysulfone or the like (generally synthetic in nature). The matrix may also be composed of sintered, fine particles of polyethylene, commonly known as porous polyethylene, such as sintered polyethylene beads. As a non-limiting examples, such material may have a density of between 0.35 and 0.55 grams per cubic centimeter, a pore size of between 5 and 40 microns, and a void volume of between 40 and 60 percent. Particulate polyethylene composed of cross-linked or ultra-high molecular weight polyethylene may also be used. An example matrix includes 1015 micron porous polyethylene from Chromex Corporation FN #38-244-1 (Brooklyn, N.Y.) and FUSION 5™ matrix available from Whatman, Inc., USA.

To perform multiple tests simultaneously, in some examples, the device includes multiple test strips, each of which can perform a different test. In other examples, a test strip of the device can include another mechanism to accomplish multiplex testing. In one embodiment, a test strip of the device can include a plurality of analyte-specific beads (e.g., bar-coded magnetic beads) to detect the presence of one or more analytes. Performing multiple tests at once on a single device can reduce testing time, costs, and waste. Example devices described herein can also reduce the need for certain types of materials (e.g., plastics), as components described herein can utilize alternative, more environmentally-friendly materials (e.g., cardboard, paper, recyclable materials, biodegradable materials, etc.). These materials can be treated to become fluid impermeable to avoid absorption of the sample and/or reagents.

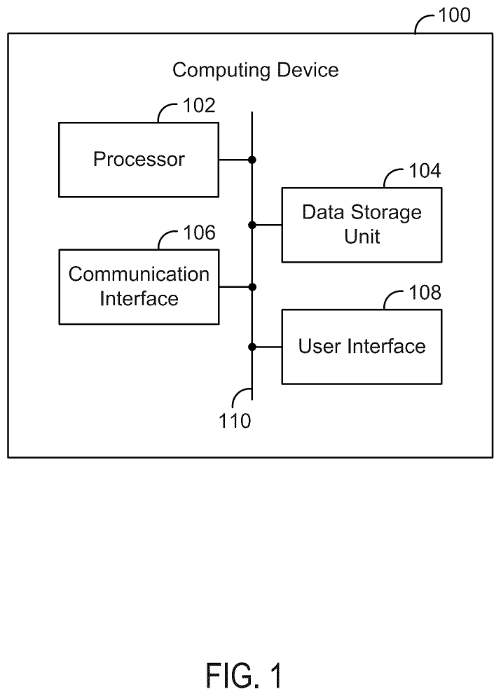

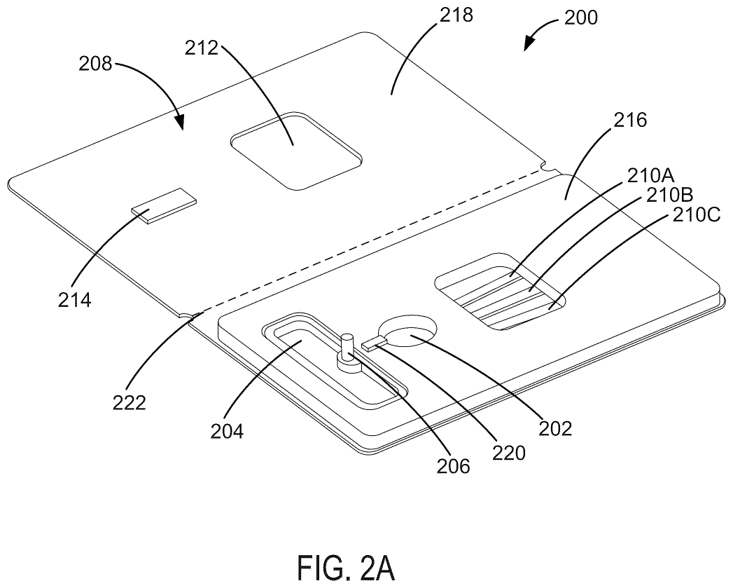

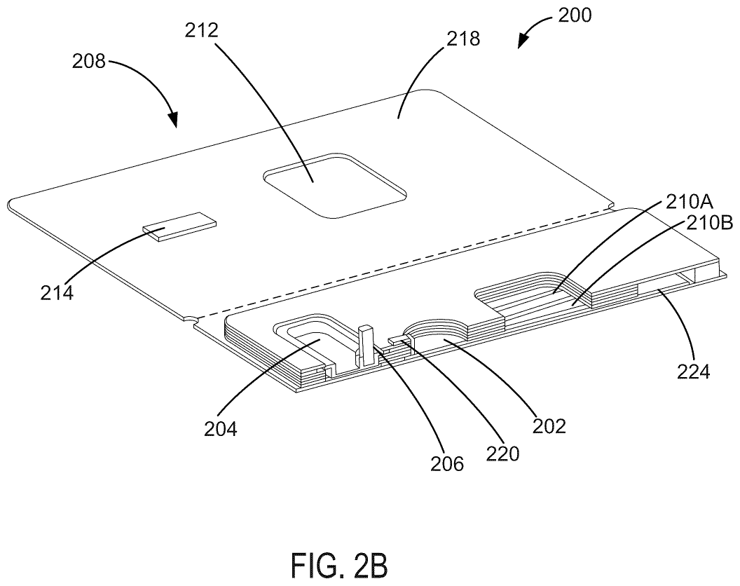

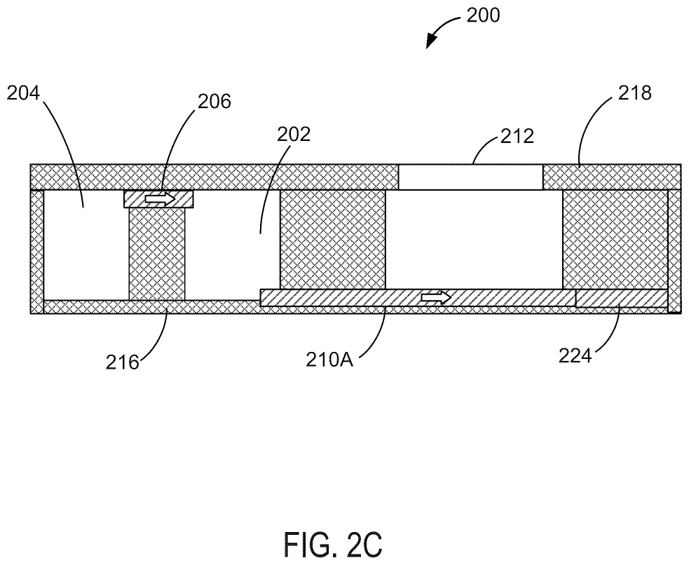

Referring now to the figures, FIG. 1 is a simplified block diagram of an example computing device 100 of a system (e.g., that can be utilized with devices and methods illustrated in FIGS. 2A-4, described in further detail below). Computing device 100 can perform various acts and/or functions, such as those described in this disclosure. Computing device 100 can include various components, such as processor 102, data storage unit 104, communication interface 106, and/or user interface 108. These components can be connected to each other (or to another device, system, or other entity) via connection mechanism 110.

Processor 102 can include a general-purpose processor (e.g., a microprocessor and/or a central processing unit (CPU)) and/or a special-purpose processor (e.g., a digital signal processor (DSP) and/or a graphics processing unit (GPU)).

Data storage unit 104 can include one or more volatile, non-volatile, removable, and/or non-removable storage components, such as magnetic, optical, or flash storage, and/or can be integrated in whole or in part with processor 102. Further, data storage unit 104 can take the form of a non-transitory computer-readable storage medium, having stored thereon program instructions (e.g., compiled or non-compiled program logic and/or machine code) that, when executed by processor 102, cause computing device 100 to perform one or more acts and/or functions, such as those described in this disclosure. As such, computing device 100 can be configured to perform one or more acts and/or functions, such as those described in this disclosure. Such program instructions can define and/or be part of a discrete software application. In some instances, computing device 100 can execute program instructions in response to receiving an input, such as from communication interface 106 and/or user interface 108. Data storage unit 104 can also store other types of data, such as those types described in this disclosure.

Communication interface 106 can allow computing device 100 to connect to and/or communicate with another other entity according to one or more protocols. In one example, communication interface 106 can be a wired interface, such as an Ethernet interface or a high-definition serial-digital-interface (HD-SDI). In another example, communication interface 106 can be a wireless interface, such as a cellular or WI FI interface. In this disclosure, a connection can be a direct connection or an indirect connection, the latter being a connection that passes through and/or traverses one or more entities, such as a router, switcher, or other network device. Likewise, in this disclosure, a transmission can be a direct transmission or an indirect transmission.

User interface 108 can facilitate interaction between computing device 100 and a user of computing device 100, if applicable. As such, user interface 108 can include input components such as a keyboard, a keypad, a mouse, a touch sensitive panel, a microphone, a camera, and/or a movement sensor, all of which can be used to obtain data indicative of an environment of computing device 100, and/or output components such as a display device (which, for example, can be combined with a touch sensitive panel), a sound speaker, and/or a haptic feedback system. More generally, user interface 108 can include hardware and/or software components that facilitate interaction between computing device 100 and the user of the computing device 100.

Computing device 100 can take various forms, such as a workstation terminal, a desktop computer, a laptop, a tablet, a mobile phone, or a controller.

Referring now to FIGS. 2A-2C which illustrate an example device 200 for testing a fluid sample. The device 200 is configured to support a sequential directional flow of a fluid sample followed by a fluid reagent across one or more test strips 210A, 210B, and 210C. The sequential directional flow of the fluid sample and the fluid reagent allows for performing one or more tests on the fluid sample.

Now referring specifically to FIGS. 2A-2B, which illustrate the example device 200 for testing a fluid sample, in a pre-actuated position. In example embodiments, the housing 208 includes a first portion 216 and a second portion 218. The first portion 216 of the housing 208 can include a sample well 202, a reagent well 204, and one or more test strips 210A, 210B, and 210C. The second portion 218 of the housing 208 can include an optically transparent viewing window 212 and optionally a strip 214.

In example implementations, the first portion 216 of the housing 208 and the second portion 218 of the housing 208 are pivotably disposed with respect to each other by means of a fold axis 222. In some examples, the fold axis 222 includes a hinge and/or perforated line. The pivotal connection initially holds the first portion 216 of the housing 208 and the second portion 218 of the device 200 in a pre-actuated configuration.

While the device 200 is in the pre-actuated position, the sample well 202 is configured to receive a sample. In some example embodiments the sample is a fluid biological sample (e.g., blood, urine, etc.). In other examples, the sample may have a more solid consistency (e.g., fecal matter, ear wax, etc.) and may be processed prior to application to sample well. A fluid diluent may be added to a sample to prepare the sample for testing. For instance, a liquid diluent may be added to the sample before depositing the sample into the sample well 202. Some example fluid diluents include, but are not limited to, Phosphate-Buffered Saline (PBS), Tris-Buffered Saline (TBS), water, saline solution, and glycerol based buffer solution.

In some example embodiments, the sample well 202 includes a bridge 220 adjacent to the reagent well 204 to further support directional flow between the reagent well 204 and the sample well 202, once the device 200 is actuated, as discussed in more detail with respect to FIG. 2C.

Once the fluid sample is deposited in the sample well 202, the one or more test strips 210A, 210B, and 210C provide a fluidic communication between the sample well 202 and an absorbent pad 224, thereby supporting a directional flow of the fluid sample from the sample well 202 to the absorbent pad 224. More particularly, the fluid sample is pulled across the one or more test strips 210A, 210B, and 210C to the absorbent pad 224 by capillary force. In example embodiments, the directional flow of the fluid sample from the sample well 202 to the absorbent pad 224 is a lateral directional flow.

In example embodiments, the reagent well 204 is adjacent to the sample well 202. The reagent well 204 can include an on-board reagent to facilitate performing the one or more tests. In examples, the fluid reagent includes (i) a binding reagent; (ii) a wash reagent; (iii) a conjugate reagent; and/or (iv) a fluorescent stain.

The reagent well 204 additionally includes a wick 206. When the device is in a pre-actuated position, as shown in FIGS. 2A-2B, the reagent well 204 is not in fluidic communication with the sample well 202. For instance, in example configurations, the wick 206 can stand vertically between the reagent well 204 and the sample well 202.

FIG. 2C shows a cross-sectional view of the device 200 in an actuated position. For clarity, only one test strip, test strip 210A, is shown in FIG. 2C. However, as noted above, the device can include additional test strips (e.g., test strip 210B and test strip 210B).

The device 200 is in an actuated position once the housing 208 actuates the wick 206. As described above, the first portion 216 of the housing 208 and the second portion 218 of the housing 208 are pivotably disposed with respect to each other by means of a fold axis 222. In some examples, the fold axis 222 includes a hinge and/or perforated line. To actuate the wick 206, the second portion 218 of the housing 208 can be placed onto (e.g., folded on top of) the first portion 216 via the fold axis 222. In example configurations, placement of the second portion 218 of the housing 208 onto of the first portion 216 of the housing 208 bends the wick 206 towards the sample well 202 so that the wick 206 can provide a fluidic communication between the reagent well 204 and the sample well 202.

In some examples, the first portion 216 of the housing 208 additionally includes a bridge 220 (shown in FIGS. 2A-2B) that further supports the fluidic communication between the reagent well 204 and the sample well 202. Additionally or alternatively, in some examples, the second portion 218 of the housing 208 can include a strip 214 that further supports the fluidic communication between the reagent well 204 and the sample well 202.

Once a volume of the fluid sample has been displaced from the sample well 202, the wick 206 supports directional flow of the fluid reagent to the sample well 202, via the wick 206 by capillary force. In examples where the device 200 includes the strip 214 and/or the bridge 220, the wick 206, the bridge 220, and the strip 214 can support the directional flow of the fluid reagent from the reagent well 204 to the sample well 202. In example embodiments, the directional flow of the fluid reagent is a lateral directional flow. Materials suitable for the bridge and the wick may be same or different than the materials used for the test strip(s) as long as the materials support the absorbance and transfer of fluid between the reagent well(s) and the test strip(s).

Once the fluid reagent is in the sample well 202, the test strips 210A, 210B, and 210C provide a fluidic communication and support a directional flow of the fluid reagent from the sample well 202 to the absorbent pad 224. Namely, once a volume of the fluid sample has been displaced from the one or more test strips 210A, 210B, and 210C, to the absorbent pad 224, the fluid reagent is delivered from the sample well 202 across the one or more test strips 210A, 210B, and 210C to the absorbent pad 224 by capillary force. In example embodiments, the directional flow of the fluid reagent is a lateral directional flow.

The sequential directional flow of the fluid sample followed by the fluid reagent across the one or more test strips 210A, 210B, and 210C allows the one or more test strips 210A, 210B, and 210C to perform one or more tests on the fluid sample. In some example implementations, performing a test involves detecting the presence of one or more analytes in the fluid sample. To do so, in some examples, the test strip can comprise at least one of the following: (i) antibodies, (ii) antigens, (iii) aptamers, or (iv) peptides.

In some example embodiments, each of the one or more test strips 210A, 210B, and 210C is configured to perform a different test for analytes that can be detected in samples and other samples as a result of a binding assay, typically an immunoassay. Example tests can include the determination of a vast variety of analytes know in the art to be detectable by, for example, immunoassay, including, but are not limited to: (i) Anaplasma, (ii) Ehrilichia, (iii) heartworm, (iv) Lyme disease, (v) Feline Immunodeficiency Virus (FIV), (vi) Feline leukemia virus (FeLV), (vii) Giardia, (viii) Parvo, (ix) Lepto, (x) hookworm, (xi) roundworm, (xii) whipworm, (xiii) tapeworm, (xiv) cystoisospora, (xv) campylobacter jejuni, (xvi) cryptosporidium, (xvii) enteric coronavirus, (xviii) salmonella, or (xix) tritrichromonas. In an example implementation, a first test strip 210A is configured to perform a Anaplasma test, a second test strip 210B is configured to perform a Ehrilichia test, and a third test strip 210C is configured to perform a heartworm test. In another example configuration, one or more of the test strips 210A, 210B, and 210C are configured to perform the same test for redundancy. Many example combinations of tests are possible.

In some example implementations, test strips of different dimensions can be utilized to control the speed and/or time of the directional flow based on the type of test and/or the type of sample.

In example implementations, the one or more test strips 210A, 210B, and 210C are configured to provide a visual indication of a testing result based on the directional flow of the fluid sample and the fluid reagent. For instance, a line can appear on the test strip 210A indicating a positive result or a negative result of a particular test. In another example, the test strip 210A may turn a certain color to indicate a positive result or negative testing result of a particular test depending on the label associated with fluid reagent(s)

In example embodiments, the second portion 218 of the housing 208 can include an optically transparent viewing window 212 suitable for viewing and/or imaging. Namely, when the device 200 is in the actuated position, the viewing window 212 is above at least a portion of the one or more test strips 210A, 210B, and 210C. This allows for a user to view the visual indication of the testing result. The optically transparent viewing window 212 additionally or alternatively allows for imaging (either visually or with an optical reader) of at least a portion of the one or more test strips 210A, 210B, and 210C.

In some examples, the first portion 216 of the housing 208 can include an optically transparent viewing window (not shown) below at least a portion of the one or more test strips 210A, 210B, and 210C. This allows for different types of imaging, such as reflection imaging and/or transmission imaging.

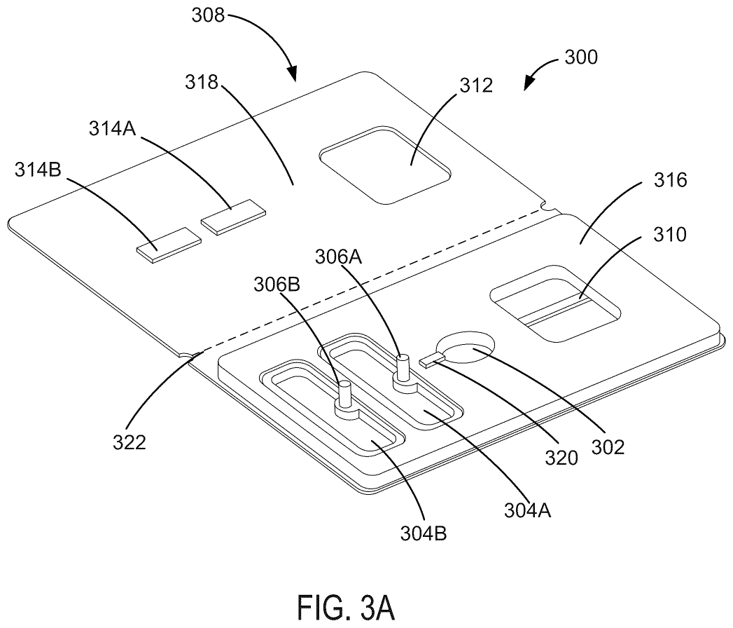

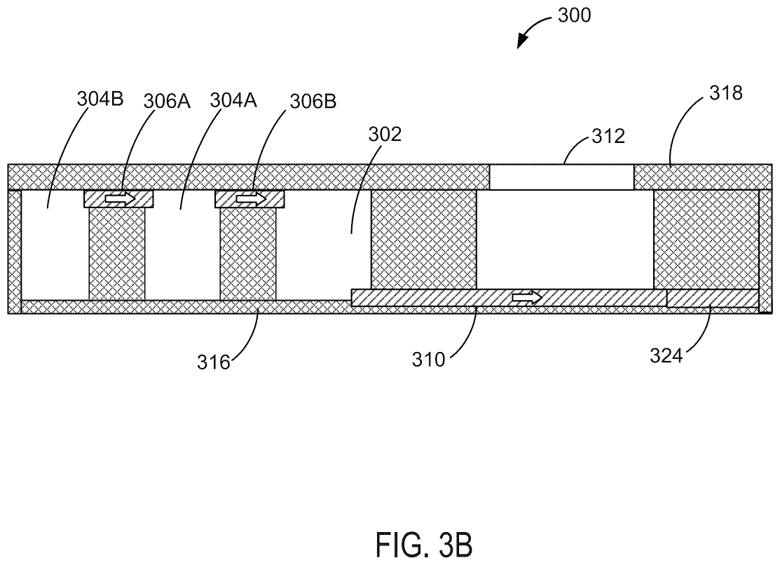

Referring now to FIGS. 3A-3B which illustrate another example device 300 for testing a fluid sample. The device 300 is configured to support a sequential directional flow of a fluid sample followed by a first fluid reagent and a second fluid reagent across a test strip 310. The sequential directional flow of the fluid sample and the fluid reagents allows for performing one or more tests on the fluid sample.

Now referring specifically to FIG. 3A, which illustrates the example device 300 for testing a fluid sample, in a pre-actuated position. In example embodiments, the housing 308 includes a first portion 316 and a second portion 318. The first portion 316 of the housing 308 can include the sample well 302, a first reagent well 304A, a second reagent well 304B, and the test strip 310. The second portion 318 of the housing 308 can include an optically transparent viewing window 312, a first strip 314A, and a second strip 314B.

In some examples, the first portion 316 of the housing 308 and the second portion 318 of the housing 308 are pivotably disposed with respect to each other by means of a fold axis 322. In some examples, the fold axis 322 includes a hinge and/or perforated line. The pivotal connection initially holds the first portion 316 of the housing 308 and the second portion 318 of the housing 308 side-by-side (i.e., open), so that the device 300 is in a pre-actuated configuration.

While the device 300 is in the pre-actuated position, the sample well 302 is configured to receive a sample. In some example embodiments the sample is a fluid sample (e.g., blood, urine, etc.). In other examples, the sample may have a more solid consistency (e.g., fecal matter, ear wax, etc.). A fluid diluent may be added to a sample to prepare the sample for testing. Some example fluid diluents include, but are not limited to, Phosphate-Buffered Saline (PBS), Tris-Buffered Saline (TBS), water, saline solution, and glycerol based buffer solution. Other example diluents are possible.

In some example embodiments, the sample well 302 includes a strip 320 adjacent to the first reagent well 304A to further support directional flow between the first reagent well 304A and the sample well 302, once the device 300 is actuated, as discussed in more detail with respect to FIG. 3B.

Once the fluid sample is deposited in the sample well 302, the test strip 310 provides a fluidic communication between the sample well 302 and an absorbent pad 324, thereby supporting a directional flow of the fluid sample from the sample well 202 to the absorbent pad 224. More particularly, the fluid sample is pulled across the test strip 310 to the absorbent pad 324 by capillary force. In example embodiments, the directional flow of the fluid sample from the sample well 302 to the absorbent pad 324 is a lateral directional flow.

In example embodiments, the first reagent well 304A is adjacent to the sample well 302. The first reagent well 304A is adjacent to the second reagent well 304B. The first reagent well 304A and the second reagent well 304B can include one more on-board reagents to facilitate performing the one or more tests. In examples, the fluid reagent includes (i) a binding reagent; (ii) a wash reagent; (iii) a conjugate reagent; or (iv) a fluorescent stain. In example configurations, the first reagent well 304A includes a binding fluid reagent and the second reagent well 304B includes a wash fluid reagent.

The first reagent well 304A and the second reagent well 304B include a first wick 306A and a second wick 306B, respectively. When the device 300 is in a pre-actuated state, as shown in FIG. 3A, first reagent well 304A and the second reagent well 304B are not in fluidic communication with each other or with the sample well 302. For instance, in example configurations, the first wick 306A and the second wick 306B can stand vertically.

Now referring to FIG. 3B, which shows a cross-sectional view of the device 300 in an actuated position. The device 300 is in an actuated position once the first wick 306A and the second wick 306B are actuated. Once the first wick 306A is actuated, the first wick 306A provides a fluidic communication between the first reagent well 304A and the sample well 302. Once the second wick 306B is actuated, the second wick 306B provides a fluidic communication between the second reagent well 304B and the first reagent well 304A.

In example implementations, the housing 308 is configured to actuate both the first wick 306A and the second wick 306B. As described above, the first portion 316 of the housing 308 and the second portion 318 of the housing 308 are pivotably disposed with respect to each other by means of a fold axis 322. In some examples, the fold axis 322 includes a hinge and/or perforated line.

To actuate the first wick 306A and the second wick 306B, the second portion 318 of the housing 308 can be placed onto (e.g., folded on top of) the first portion 316 via the fold axis 322. In example configurations, placement of the second portion 318 of the housing 308 onto the first portion 316 of the housing 308 bends the first wick 306A and the second wick 306B towards the sample well 302 and the first reagent well 304A, respectively. In doing so, the first wick 306A can provide a fluidic communication between the first reagent well 304A and the sample well 302. And the second wick 306B can provide a fluidic communication between the second reagent well 304B and the first reagent well 304A.

In some examples, the first portion 316 of the housing 308 additionally includes a first bridge 320A and a second bridge 320B (shown in FIG. 3A) that further support the fluidic communication between the first reagent well 304A and the sample well 302 and the fluidic communication between the second reagent well 304B and the first reagent well 304A, respectively. Additionally or alternatively, in some examples, the second portion 218 of the housing 208 can include a first strip 314A and a second strip 314B that further support the fluidic communication between the first reagent well 304A and the sample well 302 and the fluidic communication between the second reagent well 304B and the first reagent well 304A, respectively.

Once a volume of the fluid sample has been displaced from the sample well 302, the first fluid reagent is delivered to the sample well 302, via the first wick 306A by capillary force. In examples where the device 300 includes the first strip 314A and/or the first bridge 320A, the first wick 306A, the first bridge 320A, and the first strip 314A can support the directional flow of the first fluid reagent from the first reagent well 304A to the sample well 302. In example embodiments, the directional flow of the fluid reagent is a lateral directional flow.

Once the first fluid reagent is in the sample well 302, the test strip 310 provides a fluidic communication and supports a directional flow of the first fluid reagent from the sample well 302 to the absorbent pad 324. Namely, once a volume of the fluid sample has been displaced from the test strip 310 to the absorbent pad 224, the first fluid reagent is delivered from the sample well 302 across the test strip 310 to the absorbent pad 324 by capillary force. In example embodiments, the directional flow of the first fluid reagent is a lateral directional flow.

Once a volume of the first fluid reagent has been displaced from the first reagent well 304A, the second fluid reagent in the reagent well 304B is delivered to the first reagent well 304A via the second wick 306B by capillary force. In examples where the device 300 includes the second strip 314B and/or the second bridge 320B, the second wick 306B, the second bridge 320B, and the second strip 314B can support the directional flow of the second fluid reagent from the second reagent well 304B to the first reagent well 304A. In example embodiments, the directional flow of the second fluid reagent is a lateral directional flow.

Similarly, once a volume of the first fluid reagent has been displaced from the first reagent well 304A, the second fluid reagent is delivered to the sample well 302, via the first wick 306A by capillary force. In examples where the device 300 includes the first strip 314A and/or the first bridge 320A, the first wick 306A, the first bridge 320A, and the first strip 314A can support the directional flow of the second fluid reagent from the first reagent well 304A to the sample well 302. In example embodiments, the directional flow of the fluid reagent is a lateral directional flow.

Once the second fluid reagent is in the sample well 302, the test strip 310 provides a fluidic communication and supports a directional flow of the second fluid reagent from the sample well 302 to the absorbent pad 324. Namely, once a volume of the first fluid reagent has been displaced from the test strip 310 to the absorbent pad 324, the first fluid reagent is delivered from the sample well 302 across the test strip 310 to the absorbent pad 324 by capillary force. In example embodiments, the directional flow of the second fluid reagent is a lateral directional flow.

The sequential directional flow of the fluid sample followed by the first fluid reagent and the second fluid reagent across the test strip 310, allows the test strip 310 to perform one or more tests of the fluid sample. In some example implementations, performing a test involves detecting the presence of one or more analytes in the fluid sample. To do so, in some examples, the test strip comprises at least one of the following: (i) antibodies; (ii) antigens; or (iii) aptamers, or (iv) peptides. Example tests can include, but are not limited to antigens associated with the following: (i) Anaplasma, (ii) Ehrilichia, (iii) heartworm, (iv) Lyme disease, (v) FIV, (vi) FeLV, (vii) Giardia, (viii) Parvo, (ix) Lepto, (x) hookworm, (xi) roundworm, (xii) whipworm, (xiii) tapeworm, (xiv) cystoisospora, (xv) campylobacter jejuni, (xvi) cryptosporidium, (xvii) enteric coronavirus, (xviii) salmonella, or (xix) tritrichromonas.

In some example embodiments, the test strip 310 can include a plurality of beads (e.g., one or more types of paramagnetic, bar-coded beads). The plurality beads can be adhered to the test strip 310 to keep them in the focal plane for viewing. The plurality of beads can contain one or more identifying features (such as a unique bar code, a responsive wavelength, a color, a shape, an alphanumeric symbol, and/or the like) that can be detected independent of a signal associated with the presence of analyte. By utilizing the plurality of independently-detectable beads, the device 300 can perform multiple tests at once to detect a number of different analytes. For instance, the test strip 310 can be configured to perform an Anaplasma test, a Ehrilichia test, and a heartworm test using the same label, but with beads have a identifying feature unique to the analyte. Many example combinations of tests are possible.

In example implementations, the test strip 310 is configured to provide a visual indication of a testing result based on the directional flow of the fluid sample and the fluid reagent. For instance, a line can appear on the first test strip 210A indicating a positive result or a negative result of a particular test. In another example, the test strip 310 may turn a certain color to indicate a positive result or negative testing result of a particular test. In another example, a visual indication may not be detectable to the human eye, such as a fluorescent stain. In these examples, a user may utilize an imaging device and/or an optical reader to help determine a testing result. Many examples are possible as is well known in the immunoassay arts.

In example embodiments, the second portion 318 of the housing 308 can include an optically transparent viewing window 312 suitable for viewing and/or imaging. Namely, when the device 300 is in the actuated position, the viewing window 312 is above at least a portion of the test strip 310. The optically transparent viewing window 312 allows for imaging of at least a portion of the test strip.

In some examples, the first portion 316 of the housing 308 can include an optically transparent viewing window (not shown) below at least a portion of the test strip 310. This allows for different types of imaging, such as reflection imaging and/or transmission imaging.

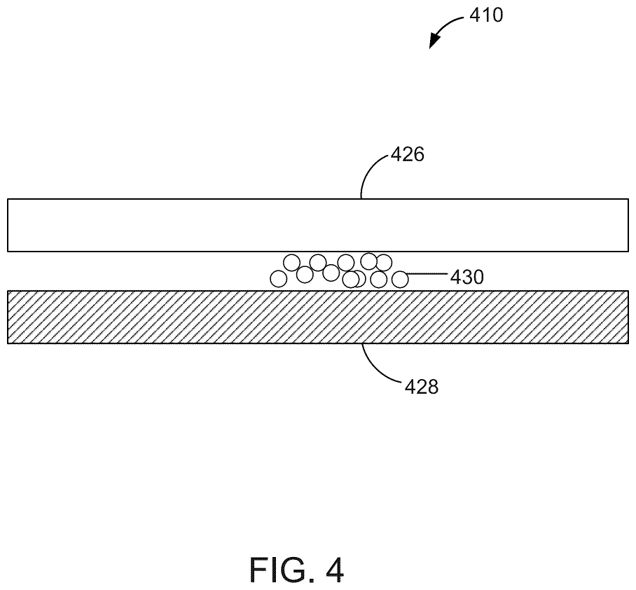

Now referring to FIG. 4, an example test strip 410 which includes one or more beads. The test strip 410 includes a top layer 426, a bottom layer 428, and a plurality of beads 430. The top layer 426 and bottom layer 428 are both generally flat sheets. In example implementations, the top layer 426 can includes clear or opaque material (e.g., glass or plastic) suitable for imaging. The bottom layer 428 can support directional flow of the fluid sample and the one or more reagents, as described herein. Additionally, the bottom layer 428 can provide visual contrast to the plurality of beads 430 for imaging purposes. The plurality beads can be adhered to the top layer 426 and/or the bottom layer 428 to keep them in the focal plane for viewing and/or imaging.

The plurality of beads 430 (e.g., one or more types of paramagnetic, bar-coded beads) contain one or more identifying features (such as a unique bar code, a responsive wavelength, a color, a shape, an alphanumeric symbol, and/or the like). These beads can include one or more of the following: microbeads, microparticles, micropellets, microwafers, microparticles containing one or more identifying features (such as a bar code, a responsive wavelength, a color, a shape, an alphanumeric symbol, and/or the like), paramagnetic microparticles, paramagnetic microparticles containing one or more bar codes, and/or beads containing one or more bar codes.

Additionally or alternatively, these beads (e.g., paramagnetic, bar-coded beads) may comprise one or more materials, including one or more of the following: glass, polymers, polystyrene, latex, elemental metals, ceramics, metal composites, metal alloys, silicon, or of other support materials such as agarose, ceramics, glass, quartz, polyacrylamides, polymethyl methacrylates, carboxylate modified latex, melamine, and Sepharose, and/or one or more hybrids thereof. In particular, useful commercially available materials include carboxylate modified latex, cyanogen bromide activated Sepharose beads, fused silica particles, isothiocyanate glass, polystyrene, and carboxylate monodisperse microspheres. Furthermore, these beads also comprise one or more specific shapes, dimensions, and/or configurations and may be modified for one or more specific uses. For example, these beads (e.g., paramagnetic, bar-coded beads) may be a variety of sizes from about 0.1 microns to about 100 microns, for example about 0.1, 0.5, 1.0, 5, 10, 20, 30, 40 50, 60, 70, 80 90 or 100 microns. In a further aspect, these particles may be surface modified and/or functionalized with biomolecules for use in biochemical analysis.

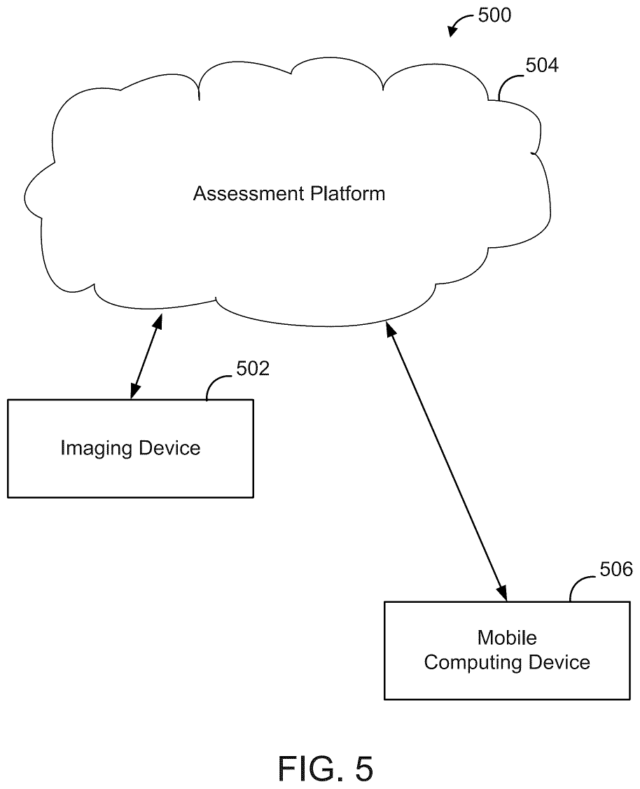

Now referring to FIG. 5, a computing system 500 configured for use with an imaging device 502 and a mobile computing device 506, according to an example embodiment. Example devices (e.g., 200 and 300) are compatible with an imaging device 502 that can read an optical signal present on the test strip. Signals may include a color or intensity of light associated with the test strip or may detect an image present on the strip that is associated with a bead (e.g., barcoded, shape, size, etc) present on the strip. An imaging device 502 includes a computing device, such as computing device 100. It should also be readily understood that computing device 100 and the imaging device 502, and all of the components thereof, can be physical systems made up of physical devices, cloud-based systems made up of cloud-based devices that store program logic and/or data of cloud-based applications and/or services (e.g., perform at least one function of a software application or an application platform for computing systems and devices detailed herein), or some combination of the two.

In any event, a computing system 500 can include various components, such as the computing device 100, imaging device 502, a cloud-based assessment platform.

The imaging device 502 and/or components thereof can perform various acts and/or functions (many of which are described above). Examples of these and related features will now be described in further detail.

The imaging device 502 may collect data from a number of sources. In one example, the imaging device 502 may collect data from a database of images related to testing of samples, including one or more images of test strips and/or beads. The images may be uploaded to an assessment platform 504 and characteristics of the images may be output to a mobile computing device 506.

In an example, assessment platform 504 may collect data from one or more sensors communicably coupled to the imaging device 502, such as an imaging sensor, concerning a particular sample. In such examples, the assessment platform 504 may identify a characteristic of the sample or a testing result and transmit instructions to the mobile computing device 506 to cause a graphical user interface to display a graphical indication of the identified characteristic and/or testing result. In some examples, the assessment platform 504 may determine a testing result by utilizing one or more of: (i) an artificial neural network, (ii) a support vector machine, (iii) a regression tree, or (iv) an ensemble of regression trees.

In another example, the imaging device 502 may collect data from one or more sensors communicably coupled to the imaging device, such as an imaging sensor, concerning a particular sample and/or test strip. In some examples, the assessment platform 504 may determine a characteristic of the sample and/or testing result by utilizing one or more of: (i) an artificial neural network, (ii) a support vector machine, (iii) a regression tree, or (iv) an ensemble of regression trees.

In some examples, images that are captured by the imaging device can be stored within a memory, such as a memory of computing device 100, to be subsequently analyzed.

In one example, the imaging device 502 may train a machine learning model using data associated images of test strips that share a characteristic with captured images of test strips. The machine learning model may be trained using training data that shares a testing result with a test strip to be analyzed by the imaging device. Training the machine learning model may include inputting one or more training images into the machine learning model, predicting, by the machine learning model, an outcome of a determined condition of the one or more training images, comparing the at least one outcome to the characteristic of the one or more training images, and adjusting, based on the comparison, the machine learning model.

In some examples, the training data may include labeled input images (supervised learning), partially labeled input images (semi-supervised learning), or unlabeled input images (unsupervised learning). In some examples, training may include reinforcement learning.

The machine learning model may include an artificial neural network, a support vector machine, a regression tree, an ensemble of regression trees, or some other machine learning model architecture or combination of architectures.

In some examples, the machine learning model of the imaging device 502 may be adjusted based on training such that if the outcome of a determined testing result matches the testing result of the training images, the machine learning model is reinforced and if the outcome of a determined testing result does not match the characteristic of the training images, the machine learning model is modified. In some examples, modifying the machine learning model includes increasing or decreasing a weight of a factor within the neural network of the machine learning model. In other examples, modifying the machine learning model includes adding or subtracting rules during the training of the machine learning model.

Once the imaging device 502 has determined a characteristic of a sample in one or more images, the imaging device may transmit instructions that cause a computing device (e.g., the computing device 100) to display one or more graphical indications of the identified characteristic and/or the enhanced image.

In example embodiments, the device can be used for a testing vast variety of samples for numerous analytes. For instance, as examples only, these tests may include detection of analytes in of one or more of the following samples: (i) blood; (ii) urine; (iii) saliva; (iv) fecal matter; (v) secretion; (vi) excretion; (vii) Fine Needle Aspirate (FNA); (viii) lavage fluids; (ix) body cavity fluids; (x) semen; (xi) ear wax; (xii) skin cells; (xiii) biopsied samples, (xiv) exotics; (xv) cultured cells; (xvi) bacteria; (xvii) worms; (xviii) parasites; and (xix) ear mites, among other possibilities.

### EXAMPLE METHODS AND ASPECTS

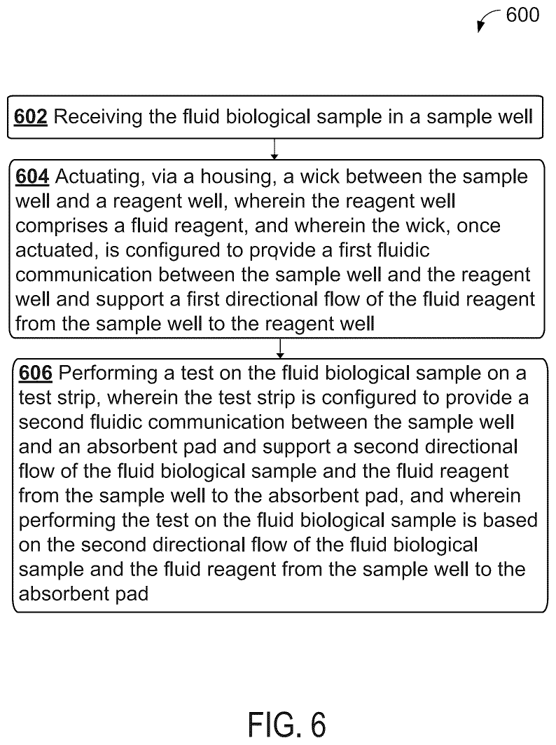

Now referring to FIG. 6, an example method for testing a fluid sample. Method 600 shown in FIG. 6 presents an example of a method of testing a fluid sample that could be used such as the example devices and/or imaging device shown in FIGS. 2A-4, for example. Further, devices or systems may be used or configured to perform logical functions presented in FIG. 6. In other examples, components of the devices and/or systems may be arranged to be adapted to, capable of, or suited for performing the functions, such as when operated in a specific manner. Method 600 may include one or more operations, functions, or actions as illustrated by one or more of blocks 602-606. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

At block 602, method 600 involves receiving the fluid sample in a sample well.

At block 604, method 600 involves actuating, via a housing, a wick between the sample well and a reagent well, wherein the reagent well comprises a fluid reagent, and wherein the wick, once actuated, is configured to provide a first fluidic communication between the sample well and the reagent well and support a first directional flow of the fluid reagent from the sample well to the reagent well.

At block 606, the method 600 involves performing a test on the fluid sample on a test strip, wherein the test strip is configured to provide a second fluidic communication between the sample well and an absorbent pad and support a second directional flow of the fluid sample and the fluid reagent from the sample well to the absorbent pad, and wherein performing the test on the fluid sample is based on the second directional flow of the fluid sample and the fluid reagent from the sample well to the absorbent pad. In some examples, performing a test on the fluid sample includes providing a visual indication of a testing result based on the second directional flow of the fluid sample from the sample well to the absorbent pad.

In some examples, the test is a first test. In these examples, method 600 involves performing a test on the fluid sample on a second test strip, wherein the second test strip is configured to provide a third fluidic communication between the sample well and the absorbent pad and support a third directional flow of the fluid sample and the fluid reagent from the sample well to the absorbent pad, and wherein performing the second test on the fluid sample is based on the third directional flow of the fluid sample and the fluid reagent from the sample well to the absorbent pad.

In some examples, the reagent well is a first reagent well, the fluid reagent is a first fluid reagent, the wick is a first wick. In these examples, method 600 involves actuating, via the housing, a second wick between the first reagent well and a second reagent well, wherein, once actuated, the second wick is configured to provide a third fluidic communication between the second reagent well and the first reagent well and support a third directional flow of the second fluid reagent from the second reagent well to the first reagent well, wherein the first wick is configured to support the first directional flow of the first fluid reagent and the second fluid reagent from the first reagent well to the sample well, and wherein the test strip is configured to support the second directional flow of the fluid sample, the first fluid reagent, and the second fluid reagent from the sample well to the absorbent pad.

In some examples, method 600 involves capturing one or more images of at least a portion of the test strip.

The singular forms of the articles “a,” “an,” and “the” include plural references unless the context clearly indicates otherwise. For example, the term “a compound” or “at least one compound” can include a plurality of compounds, including mixtures thereof.

Various aspects and embodiments have been disclosed herein, but other aspects and embodiments will certainly be apparent to those skilled in the art. Additionally, the various aspects and embodiments disclosed herein are provided for explanatory purposes and are not intended to be limiting, with the true scope being indicated by the following claims.

What is claimed is:

1. A device for testing a fluid sample, the device comprising:
a sample well configured to receive the fluid sample;
a reagent well, the reagent well comprising a fluid reagent and a wick;
a housing configured to actuate the wick, wherein, once actuated, the wick is configured to provide a first fluidic communication between the sample well and the reagent well and support a first directional flow of the fluid reagent from the sample well to the reagent well; and
a test strip configured to provide a second fluidic communication between the sample well and an absorbent pad and support a second directional flow of the fluid sample and the fluid reagent from the sample well to the absorbent pad.

2. The device of claim 1, wherein the test strip is further configured to provide a visual indication of a testing result based on the second directional flow of the fluid sample and the fluid reagent from the sample well to the absorbent pad.

3. The device of claim 1, wherein at least one of the first directional flow and the second directional flow comprise a lateral directional flow.

4. The device of claim 1, wherein the test strip is a first test strip configured to perform a first test based on the second directional flow of the fluid sample from the sample well to the absorbent pad, and
wherein the device comprises a second test strip configured to provide a third fluidic communication between the sample well and the absorbent pad and support a third directional flow of the fluid sample and the fluid reagent from the sample well to the absorbent pad, wherein the second test strip is configured to perform a second test based on the third directional flow of the fluid sample from the sample well to the absorbent pad.

5. The device of claim 1, wherein the reagent well is a first reagent well, and wherein the fluid reagent is a first fluid reagent, wherein the wick is a first wick, and wherein the device comprises:
a second reagent well comprising a second fluid reagent; and
a second wick, wherein, once actuated, the second wick is configured to provide a third fluidic communication between the second reagent well and the first reagent well and support a third directional flow of the second fluid reagent from the second reagent well to the first reagent well,
wherein the housing is configured to actuate the second wick,
wherein, the first directional flow includes directional flow of the first fluid reagent and the second fluid reagent from the first reagent well to the sample well, and
wherein the second directional flow includes the fluid sample, the first fluid reagent, and the second fluid reagent from the sample well to the absorbent pad.

6. The device of claim 1, wherein the housing comprises an optically transparent viewing window above at least a portion the test strip.

7. The device of claim 6, wherein the optically transparent viewing window is a first optically transparent viewing window, and wherein the housing comprises a second optically transparent viewing window below at least the portion of the test strip.

8. The device of claim 1, wherein the fluid sample comprises one of the following: (i) blood; (ii) urine; (iii) saliva; (iv) fecal matter; (v) secretion; (vi) excretion; (vii) Fine Needle Aspirate (FNA); (viii) lavage fluids; (ix) body cavity fluids; (x) semen; (xi) ear wax; (xii) skin cells; (xiii) biopsied samples, (xiv) exotics; (xv) cultured cells; (xvi) bacteria; (xvii) worms; (xviii) parasites; or (xix) ear mites.

9. The device of claim 1, wherein the fluid reagent comprises at least one of the following: (i) a binding reagent; (ii) a wash reagent; (iii) a conjugate reagent; or (iv) a fluorescent stain.

10. The device of claim 1, wherein the test strip comprises at least one of the following: (i) antibodies; (ii) antigens; (iii) aptamers; or (iv) peptides.

11. The device of claim 1, wherein the test strip comprises a plurality of bar-coded magnetic beads.

12. A method for testing a fluid sample, the method comprising:
receiving the fluid sample in a sample well;
actuating, via a housing, a wick between the sample well and a reagent well, wherein the reagent well comprises a fluid reagent, and wherein the wick, once actuated, is configured to provide a first fluidic communication between the sample well and the reagent well and support a first directional flow of the fluid reagent from the sample well to the reagent well; and
performing a test on the fluid sample on a test strip, wherein the test strip is configured to provide a second fluidic communication between the sample well and an absorbent pad and support a second directional flow of the fluid sample and the fluid reagent from the sample well to the absorbent pad, and wherein performing the test on the fluid sample is based on the second directional flow of the fluid sample and the fluid reagent from the sample well to the absorbent pad.

13. The method of claim 12, wherein performing a test on the fluid sample includes providing a visual indication of a testing result based on the second directional flow of the fluid sample from the sample well to the absorbent pad.

14. The method of claim 12, wherein the test is a first test, and wherein the method comprises:
performing a test on the fluid sample on a second test strip, wherein the second test strip is configured to provide a third fluidic communication between the sample well and the absorbent pad and support a third directional flow of the fluid sample and the fluid reagent from the sample well to the absorbent pad, and wherein performing the second test on the fluid sample is based on the third directional flow of the fluid sample and the fluid reagent from the sample well to the absorbent pad.

15. The method of claim 12, wherein the reagent well is a first reagent well, the fluid reagent is a first fluid reagent, the wick is a first wick, and wherein the method comprises:
actuating, via the housing, a second wick between the first reagent well and a second reagent well, wherein, once actuated, the second wick is configured to provide a third fluidic communication between the second reagent well and the first reagent well and support a third directional flow of the second fluid reagent from the second reagent well to the first reagent well.
wherein the first wick is configured to support the first directional flow of the first fluid reagent and the second fluid reagent from the first reagent well to the sample well, and
wherein the test strip is configured to support the second directional flow of the fluid sample, the first fluid reagent, and the second fluid reagent from the sample well to the absorbent pad.

16. The method of claim 12, comprising:
capturing one or more images of at least a portion of the test strip.

17. The method of claim 12, wherein the fluid reagent comprises at least one of the following: (i) a binding reagent; (ii) a wash reagent; (iii) a conjugate reagent; or (iv) a fluorescent stain.

18. The method of claim 12, wherein the test strip comprises a plurality of bar-coded magnetic beads.

19. A system for testing a fluid sample, the system comprising:
a testing device comprising:
a sample well configured to receive the fluid sample;
a reagent well, adjacent to the sample well, the reagent well comprising a fluid reagent and a wick;
a housing configured to actuate the wick, wherein, once actuated, the wick is configured to provide a first fluidic communication between the sample well and the reagent well and support a first directional flow of the fluid reagent from the sample well to the reagent well; and
a test strip configured to provide a second fluidic communication between the sample well and an absorbent pad and support a second directional flow of the fluid sample and the fluid reagent from the sample well to the absorbent pad; and
an imaging device comprising:
an imaging sensor configured to capture one or more images of the test strip; and
a computing device configured to analyze the captured one or more images.

20. The system of claim 19, wherein at least one of the first directional flow and the second directional flow comprise a lateral directional flow.
